(19) United States
(12) Patent Application Publication
(10) Pub. No.: US 2007/0116472 A1
(43) Pub. Date: May 24, 2007

(54) Package for optical transceiver module

(75) Inventors: Sung Il Kim, Daejeon (KR); Jong Tae Moon, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/477,896

(22) Filed: Jun. 28, 2006

(30) Foreign Application Priority Data
Nov. 24, 2005 (KR) 2005-113006

(51) Int. Cl. H04B 10/00

(52) U.S. Cl. 398/135

(57) ABSTRACT

Provided is a package having high-density lead wires for an optical transceiver module. The package for an optical transceiver module includes a stem having through holes, a metal mount positioned on an upper surface of the stem, a signal line disposed in the metal mount, and a plurality of lead wires protruding from a lower surface of the stem and electrically connected to an optical device mounted on the metal mount through the through holes. Thus, the lead wires can be connected to both of an upper surface and lower surface of the metal mount, thereby increasing a signal density in the package.

### CROSS-REFERENCE TO RELATED APPLICATION

This application claims priority to and the benefit of Korean Patent Application No. 2005-113006, filed Nov. 24, 2005, the disclosure of which is incorporated herein by reference in its entirety.

### BACKGROUND

1. Field of the Invention

The present invention relates to a package for optical semiconductor devices, and more particularly, to a high-density small package for a monolithic-integrated bidirectional optical transceiver module.

2. Discussion of Related Art

Currently, while new services such as high-speed multimedia Internet, video conference, Internet protocol (IP) telephony, video on demand, Internet game, telecommuting, electronic commerce, tele-education, e-learning, distance learning, telemedicine, and so on are gradually being realized and a transmission capacity of a backbone network considerably increases, a transmission capacity of a subscriber network is hardly changed. This means that a bottleneck phenomenon may occur between subscribers and a backbone network when various multimedia services are provided using the subscriber network. Even neither x digital subscriber line (xDSL), which is currently the most widely used subscriber network solution, nor cable modem network can provide the above-mentioned services. There is a need for a new technology capable of accommodating all of data, sound, and video services with an inexpensive, simple network architecture and excellent scalability.

Recently, an Ethernet passive optical network (PON) technology has come into the spotlight as a new subscriber network technology. PONs roughly includes an asynchronous transfer mode (ATM) PON and an Ethernet PON (E-PON). The ATM PON has been developed to provide all of IP data service, video service, and high-speed service such as 10/100 Mbps Ethernet at a low cost and in a high speed. However, an ATM-PON standard is not suitable for subscriber networks because of its insufficient video transmission capability and bandwidth, and high complexity and cost. Accordingly, high-speed Ethernet, giga-byte Ethernet, and the like are developed and eventually an Ethernet PON having a bandwidth of 1.25 Gbps is emerged.

A monolithic integrated bidirectional optical transceiver module for an Ethernet PON comprises, on a single semiconductor chip, a photodetector for receiving an optical signal, a laser diode for transmitting the optical signal, a monitor photodetector for monitoring operation of the laser diode, an electronic device, and a package component. The monolithic integrated bidirectional optical transceiver module is intended to enable an electric signal converted from an optical signal by the photodetector to be input to the electronic device disposed in the module and thereby to be amplified and modulated, and intended to enable an electrical signal input to the electronic device to be converted into an optical signal by the laser diode and thereby to be transmitted to an optical fiber. Therefore, in a package for the monolithic integrated bidirectional optical transceiver module, a number of lead frames increases. Thus, signal lines of a small TO(Transceiver Optical)-can package having a diameter of 4.6 mm or 5.6 mm should be disposed at a high density in order to implement the module in a small size.

A conventional TO-can package for an optical transmission module is shown in FIGS. 1A and 1B. As illustrated in FIGS. 1A and 1B, the conventional TO-can package is configured using a stem 113. A pair of lead terminals 105 for a photodiode and a lead terminal 112 for signal transmission pass through the stem 113 and are isolated from the stem 113 by a glass material 106. In addition, a metal mount 901 on which a sub-mount 102 and a semiconductor laser 103 are mounted is mounted adjacent to the lead terminal 112 for signal transmission on an upper surface of the stem 113. Also, another sub-mount 108 and a photodiode 107 for monitoring are mounted on a recessed floor 109 of the upper surface. Here, the photodiode 107 for monitoring is mounted at a position where laser beam is input, the laser beam being emitted from a surface opposite to an emitting surface of the semiconductor laser 103. In FIG. 1A, a reference numeral 114 denotes a lead terminal for grounding.

In this manner, the above-described conventional optical transmission module is configured by providing the stem 113 for a TO-can package, mounting the semiconductor laser 103 with the sub-mount 102 located on one side of the metal mount 901, mounting the photodiode 107 for monitoring on the recessed floor 109 with the sub-mount 108, and connecting between the semiconductor laser 103/photodiode 107 and the lead terminals by wires 104, 110 and 111.

FIGS. 2A and 2B show another conventional TO-can package for an optical transmission module. The TO-can package shown in FIGS. 2A and 2B has the same structure as the conventional TO-can package described above with reference to FIGS. 1A and 1B, except that it uses a new mount 101 to enhance a radio frequency (RF) characteristic. Therefore, the reference numerals used in FIGS. 1A and 1B are also used in FIGS. 2A and 2B. In FIGS. 2A and 2B, the mount 101 is formed of a metal having excellent electric conductivity and thermal conductivity. The mount 101 has a side surface 101b on which a semiconductor laser 103 is mounted, and a circumferential surface 101a surrounding a lead terminal 112 for signal transmission. The semiconductor laser 103 is mounted on the side surface 101b using a sub-mount 102. The mount 101 is disposed on an upper surface of the stem 113 so that the semiconductor laser 103 is positioned substantially in a center of the upper side of the stem 113 and the circumferential surface 101a is concentric with the lead terminal 112 for signal transmission. In this TO-can package, the circumferential surface 101a of the mount 101 is formed to have substantially the same diameter as a through hole into which the lead terminal 112 for signal transmission is inserted.

However, the conventional arts set forth above are intended to develop a TO-can package for an optical semiconductor laser or optical semiconductor photodiode. More specifically, the TO-can package for only an optical semiconductor laser or optical semiconductor photodiode generally comprises one or two high-speed signal lead wires, one direct current (DC) signal lead wire, and one ground lead wire. Thus, the TO-can package has a drawback in that a density of the signal lines on a stem having a diameter of 4.6 mm or 5.6 mm is very low. Therefore, since the TO-can package set forth above is difficult to apply to a monolithic integrated bidirectional optical transceiver module, a new TO-can package is required.

In other words, a monolithic integrated bidirectional optical transceiver module comprises a trans-impedance amplifier chip for primarily amplifying a signal photoelectrically converted by an optical semiconductor photodiode, and a single optical semiconductor chip including an optical semiconductor laser, a monitor photodiode and an optical semiconductor photodiode. Therefore, a package for the module needs a total of nine signal lead wires including at least one high-speed signal transmission lead wire for the optical semiconductor laser, one lead wire for the monitor photodiode, two high-speed signal transmission lead wires for the trans-impedance amplifier, one DC signal lead wire for the trans-impedance amplifier, and four ground lead wires for controlling signal interference between the optical semiconductor laser and optical semiconductor photodiode. The single optical semiconductor chip may further comprise an optical amplifier upon demands. In this case, the package may further require one signal lead wire for the optical amplifier and one signal lead wire for checking operational performance of the trans-impedance amplifier. Accordingly, the package requires a total of eleven signal lead wires.

However, the conventional arts have a limit in that only four or five lead wires are allowed to be formed within the same package size, e.g., a diameter of 4.6 mm or 5.6 mm because they utilize only the upper surface and one side surface of the metal mount 901 or 101 formed on the stem 113, as seen in FIGS. 1A, 1B, 2A and 2B.

### SUMMARY OF THE INVENTION

It is an object of the present invention to provide a high-density package for miniaturizing a monolithic integrated bidirectional optical transceiver module developed to implement an Ethernet passive optical network (PON) technology. In other words, the present invention is directed to provide a package for an optical transceiver module capable of significantly increasing signal density within the same size.

One aspect of the present invention provides a package for an optical transceiver module, comprising a stem having through holes; a metal mount positioned on an upper surface of the stem; a signal line disposed in the metal mount; and a plurality of lead wires protruding from a lower surface of the stem and electrically connected to an optical device mounted on the metal through the through holes.

The signal line may pass through the metal mount and be isolated from the metal mount by an insulator.

The signal line may be separately fabricated, and be disposed in a groove of the metal mount.

The lead wires may extend parallel to the largest surface of the metal mount.

One of the lead wires may pass through the metal mount and be disposed for intended impedance matching upon high-speed signal transmission.

An end of one of the lead wires may be exposed on a side surface of the metal mount for intended impedance matching upon high-speed signal transmission.

The lead wires may be united as a lead-wire group having a same characteristic.

The optical device may include a bidirectional semiconductor device in which an optoelectronic device for transmitting an optical signal, a monitor photoelectronic device for monitoring operation of the optoelectronic device, and a photoelectronic device for receiving the optical signal are monolithically integrated.

The metal mount may have a trans-impedance amplifier mounted thereon, the trans-impedance amplifier amplifying and modulating an electric signal converted by the photoelectronic device.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIGS. 1A and 1B are diagrams illustrating a conventional TO-can package for an optical transmission module;

FIGS. 2A and 2B are diagrams illustrating another conventional TO-can package for an optical transceiver module;

FIG. 3A is a perspective view of a package for an optical transceiver module according to a first exemplary embodiment of the present invention;

FIG. 3B is another perspective view of the package of FIG. 3A when viewed from the opposite side;

FIG. 4A is a perspective view of a package for an optical transceiver module according to a second exemplary embodiment of the present invention;

FIG. 4B is another perspective view of the package of FIG. 4A when viewed from the opposite side; and

FIG. 5 is a perspective view of a package for an optical transceiver module according to a third exemplary embodiment of the present invention.

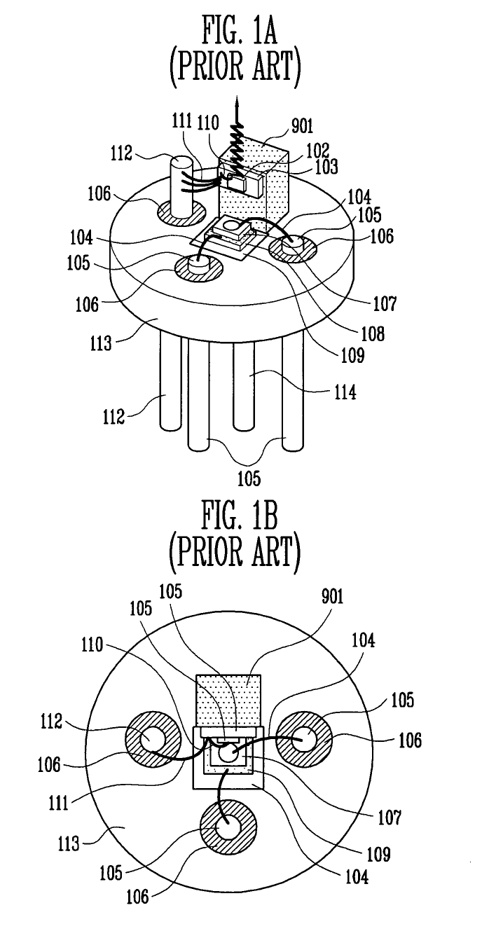

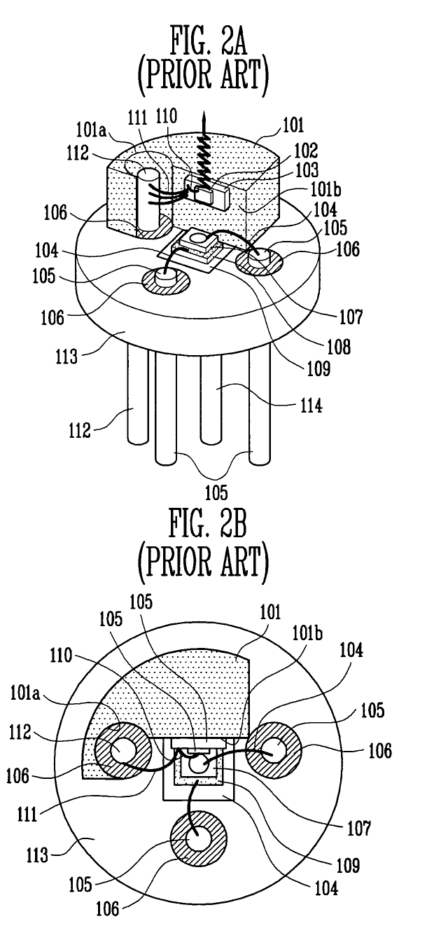

### DETAILED DESCRIPTION OF PREFERRED EMBODIMENTS

Hereinafter, an exemplary embodiment of the present invention will be described in detail. However, the present invention is not limited to the embodiments disclosed below, but can be implemented in various types. Therefore, the present embodiment is provided for complete disclosure of the present invention and to fully inform the scope of the present invention to those ordinarily skilled in the art. Like elements are denoted by like reference numerals throughout the drawings. Matters related to the present invention and well-known in the art will not be described in detail when deemed that such description would detract from the clarity and concision of the disclosure.

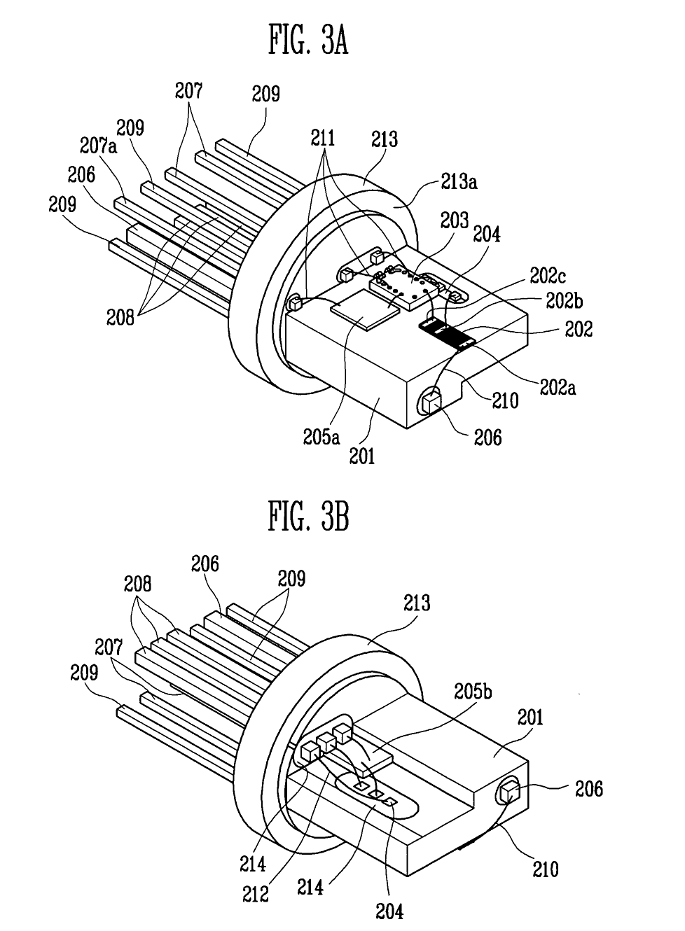

FIG. 3A is a perspective view of a package for an optical transceiver module according to a first exemplary embodiment of the present invention, and FIG. 3B is another perspective view of the package of FIG. 3A when viewed from the opposite side.

Referring to FIGS. 3A and 3B, the package for an optical transceiver module according to this embodiment includes a stem 213, a metal mount 201, signal lines 204 (hereinafter, referred to as “connection signal lines” to be distinguished from other signal lines or lead wires), and a plurality of lead wires 206, 207, 207a, 208 and 209.

The stem 213 is a component of the TO(Transceiver Optical)-can package, and has through holes that pass through the upper surface and lower surface thereof. The through holes may be formed to have a cross section of circular shape, oval shape, or the like. The stem 213 further includes a step portion 213a in the upper surface thereof for connection with a cap or an optical fiber cable (not shown in the drawings).

The metal mount 201 is made of a metal or alloy having excellent durability and thermal conductivity, and mounted on the upper surface of the stem 213. A laser diode, a monitor photodetector, and a photodetector are mounted on one side surface of the metal mount 201. The laser diode converts an electric signal such as a radio frequency (RF) signal into an optical signal and emits the optical signal, the monitor photodetector monitors operation of the laser diode, and the photodetector receives an optical signal and converts the optical signal into an electric signal. In this embodiment, a bidirectional semiconductor device 202 in which the laser diode, the monitor photodetector, and the photodetector are monolithically integrated is used. In FIG. 3A, reference numerals 202a, 202b and 202c respectively denote the laser diode, monitor photodetector, and photodetector in the monolithic integrated bidirectional semiconductor device 202. Also, the one side surface of the metal mount 201 denotes the largest surface which is nearly orthogonal to the upper surface of the stem 213 and on which the optical device 202 is mounted.

In addition, a trans-impedance amplifier 203 and capacitors 205a and 205b are mounted on the one side surface of the metal mount 201 or the other side surface thereof facing the one side surface. The trans-impedance amplifier 203 amplifies and modulates the electric signal converted by the laser diode 202a, the capacitor 205a removes noise of the trans-impedance pre-amplifier 203, and the capacitor 205b removes noise for direct current (DC) stabilization. The three connection signal lines 204 are disposed to pass through the metal mount 201 and to be exposed on the one side surface and the other side surface. Meanwhile, an impedance-matching resistor and a capacitor may be additionally mounted on the one side surface or the other side surface of the metal mount 201 upon demands.

The lead wires 206, 207, 207a, 208 and 209 are disposed to extend substantially parallel to the one side surface and the other side surface of the metal mount 201. In addition, the lead wires 206, 207, 207a, 208 and 209 protrude from the lower surface of the stem 213, extended through the through holes of the stem, and electrically connected to the optical device 202 mounted on the one side surface of the metal mount 201 through bonding wires 210, 211 and 212(hereinafter, referred also to as “wires”).

One lead wire 206 among the lead wires is disposed to pass through the metal mount 201, with an end of the lead wire 206 protruding from another side surface facing a side surface joined to the upper surface of the stem 213. This is to consider intended impedance for high-speed signal transmission. The end of the lead wire 206 is connected to the laser diode 202a positioned on the other side surface of the metal mount 201 through the wire 210.

Two lead wires 207 among the lead wires are connected to the trans-impedance amplifier 203 through the wires 211. The trans-impedance amplifier 203 is connected to the photodetector 202c for optical signal reception, to one end of a middle connection signal line among the three connection signal lines 204, and to the capacitor 205a for removing impedance amplifier's noise through other wires.

One lead wire 207a among the lead wires transmits a DC signal, and is connected to the capacitor 205a for removing impedance amplifier's noise through the wire 211.

Three lead wires 208 among the lead wires are respectively connected to the other ends of the three connection signal lines 204 through the wires 212. Here, one of the three lead wires 208 is connected to the other end of the middle connection signal line among the three connection signal lines 204 through the noise-removal capacitor 205b for DC stabilization, and another of the three lead wires 208 is electrically connected to the monitor photodetector 202b through the connection signal line 204.

Remaining four lead wires 209 among the lead wires are ground lead wires for controlling signal interference between the laser diode 202a and the photodetector 202c. Each lead wire except the ground lead wires is isolated from the stem 213 by insulators 214 such as a glass insulator and a ceramic insulator. Similarly, the connection signal lines 204 are isolated from the metal mount 201 by the insulator 214 such as a glass insulator and a ceramic insulator.

Each lead wire described above is designed to have specific intended impedance by coaxial-cable impedance matching. For example, each lead wire is designed to have intended impedance by the size of the lead wire protruding from the lower surface of the stem 213 and by intervals between the lead wires. In addition, in the present invention, lead wires having the same characteristic are united in an oval shape such that a signal density increases.

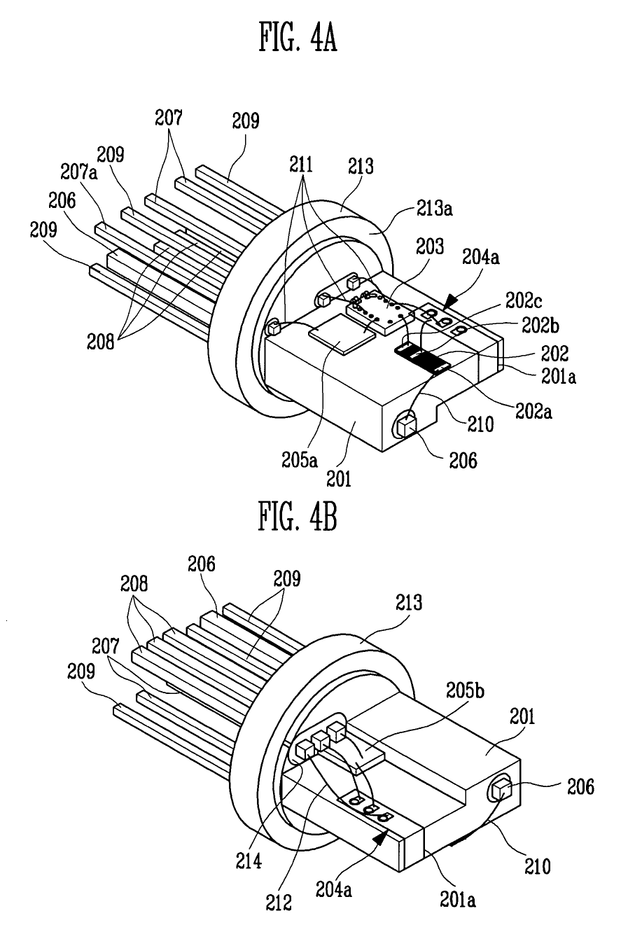

FIG. 4A is a perspective view of a package for an optical transceiver module according to a second exemplary embodiment of the present invention, and FIG. 4B is another perspective view of the package of FIG. 4A when viewed from the opposite side.

Referring to FIGS. 4A and 4B, the package for an optical transceiver module according to the second embodiment is characterized in that connection signal lines are separately fabricated and disposed in a groove 201a of a metal mount 201, unlike the package for an optical transceiver module of the first embodiment.

In other words, in this embodiment, the connection signal lines are not fabricated together with the metal mount 201. A connection signal line block 204a that is separately fabricated is mounted after the groove 201a of [symbol] shape is formed in the metal mount 201. With this structure, it is easy and simple to fabricate the connection signal lines being disposed in the metal mount, and thus the package manufacturing process can be simplified compared to the first embodiment.

Meanwhile, the groove 201a of the metal mount can be formed in a proper shape like [symbol] other than the shape mentioned above. The connection signal line can be formed of a conductor coated on or filled in the inner circumference surface of a via having a circular cross-section, or of a conductor having a quadrangular cross-section, like the connection signal lines of the first embodiment. Similarly, lead wires can be formed to have another cross-section such as a circular cross-section other than the quadrangular cross-section.

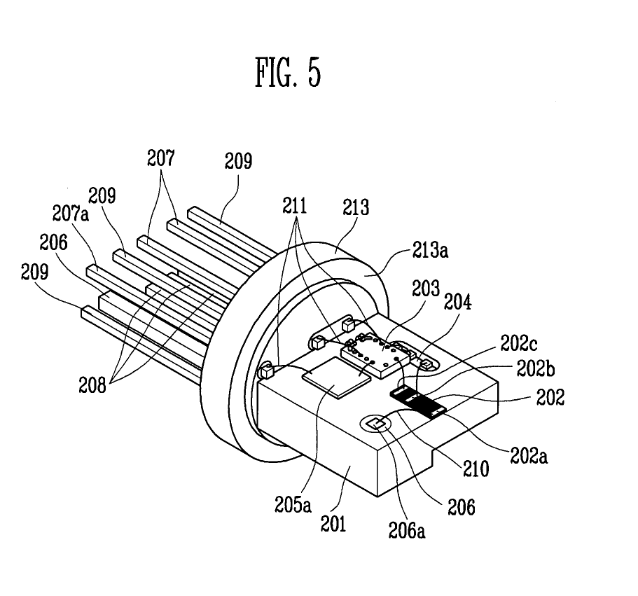

FIG. 5 is a perspective view of a package for an optical transceiver module according to a third exemplary embodiment of the present invention.

Referring to FIG. 5, the package for an optical transceiver module according to the third embodiment is characterized in that a lead wire 206 passing through a metal mount 201 is not exposed on an upper side surface of the metal mount 201 but an end 206a of the lead wire 206 is exposed on the one side surface, unlike the package of the first embodiment. Here, the one side surface of the metal mount 201 indicates a surface on which a monolithic integrated bidirectional semiconductor device 202 is mounted.

The lead wire 206 is designed considering intended impedance upon high-speed signal transmission. With the structure described above, the lead wire 206 can be designed to pass through the metal mount 201 or to be exposed on one surface of the metal mount 201, thereby increasing the freedom degree of design.

Meanwhile, the package for an optical transceiver module according to third embodiment may be implemented so that a separately fabricated connection signal line block is disposed in a groove of the metal mount 201, like the connection signal line block of the second embodiment.

As described above, the present invention allows lead wires to be connected to both of one side surface and the opposite surface of a metal mount mounted on a stem, thereby increasing a signal density more than two times in a package having the same size. In other words, the present invention can increase the density of lead wires included in a TO-can package having a diameter of 4.6 mm or 5.6 mm in order to miniaturize a monolithic integrated bidirectional module for a 1.25 Gbps Ethernet Passive Optical Networks.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A package for an optical transceiver module, comprising:
a stem having through holes;
a metal mount positioned on an upper surface of the stem;
a signal line mounted on the metal mount; and
a plurality of lead wires protruding from a lower surface of the stem and electrically connected to an optical device mounted on the metal mount through the through holes.

2. The package of claim 1, wherein the signal line passes through the metal mount and is isolated from the metal mount by an insulator.

3. The package of claim 1, wherein the signal line is separately fabricated and is disposed in a groove of the metal mount.

4. The package of claim 1, wherein the plurality of lead wires extend parallel to the largest surface of the metal mount.

5. The package of claim 4, wherein one of the plurality of lead wires passes through the metal mount for intended impedance matching upon high-speed signal transmission.

6. The package of claim 4, wherein one of the plurality of lead wires has an end exposed on one surface of the metal mount for intended impedance matching upon high-speed signal transmission.

7. The package of claim 4, wherein the plurality of lead wires are united as a lead-line group having a same characteristic.

8. The package of claim 1, wherein the optical device includes a bidirectional semiconductor device in which an optoelectronic device for transmitting an optical signal, a monitor photoelectronic device for monitoring operation of the optoelectronic device, and a photoelectronic device for receiving the optical signal are monolithically integrated.

9. The package of claim 8, wherein the metal mount has a trans-impedance amplifier mounted thereon, the amplifier amplifying and modulating an electric signal converted by the photoelectronic device.
